(19) United States
(12) Patent Application Publication
(10) Pub. No.: US 2012/0009438 A1
(43) Pub. Date: Jan. 12, 2012

(54) TRIAZINE CONTAINING FLUOROELASTOMERS HAVING LOW GLASS TRANSITION TEMPERATURE

(75) Inventors: Rudolf J. Dams, Antwerp (BE); Steven G. Corveleyn, Knokke-Heist (BE); Werner M. A. Grootaert, Oakdale, MN (US); Gregg D. Dahlke, St. Paul, MN (US); Miguel A. Guerra, Woodbury, MN (US)

(73) Assignee: 3M Innovative Properties Company

(21) Appl. No.: 12/833,522

(22) Filed: Jul. 9, 2010

(51) Int. Cl. B32B 9/00; C08L 27/12; C08F 214/18

(52) U.S. Cl. 428/704; 525/326.3; 524/544

(57) ABSTRACT

There is provided a curable fluoroelastomer composition comprising
i. a first compound which comprising repeating units derived from a fluorinated olefin and further comprising at least one functional group,
ii. a second compound comprising repeating units selected from (—C₄F₈O—), (—C₂F₄O—) or (—CF₂O) or a combination thereof and further containing at least one functional group capable of reacting with the at least one functional group of the first compound either directly or in the presence of a curing compound to form a triazine unit,
   wherein the composition after curing by forming triazine units has a glass transition temperature of less than −60° C. Also provided are shaped articles comprising the cured compositions, methods of making cured compositions and methods for making shaped articles.

### FIELD

The present disclosure relates to triazine containing fluoroelastomers having low glass transition temperatures. The present disclosure further relates to the curable precursor compositions for triazine containing fluoroelastomers and to a method of making triazine containing fluoroelastomers and methods of making shaped articles from those elastomers. The disclosure further relates to articles containing cured fluoroelastomers.

### BACKGROUND ART

Fluoroelastomers are polymeric materials that offer protection against high service temperatures and are resistant to a wide variety of chemical reagents. Fluoroelastomers furthermore have sufficient mechanical strength such that they can form shaped articles. Consequently, fluoroelastomers are particularly well adapted for making seals and gaskets and other molded elastomeric parts in systems that are exposed to elevated temperatures and/or corrosive chemicals. Such parts are widely used in the chemical processing, semiconductor, aerospace and petroleum industries, to name just a few.

Fluoroelastomers typically contain cure-site monomers which provide cross-linking sites to cross-link the polymers and to generate or enhance the elastomeric properties of the material. To accomplish this, typically a small percentage of a cure site monomer is copolymerized with the fluorinated monomer units. One class of cure site monomers widely used are nitrile group-containing cure site monomers. Fluorinated polymers comprising these cure site monomers can be cured (cross-linked) through trimerization of the nitrile groups to form triazine cross-linked polymers.

The good chemical and heat resistance of fluoroelastomers is attributable largely to the copolymerized fluorinated monomer units that make up the major portion of the polymer backbone. Based on the monomers used, fluoroelastomers are generally divided in two main classes, namely fluoroelastomers that contain repeating units derived vinylidene fluoride (VDF) and perfluoroelastomers that are made up of repeating units derived from tetrafluoro ethylene (TFE). VDF-based fluoroelastomers tend to have a lower chemical and heat resistance compared to TFE-based fluoroelastomers. The latter have a higher chemical resistance, but tend to have higher glass transition temperatures, which reduces their elastomeric properties at low temperatures.

### SUMMARY

There is a continuous need to provide fluoroelastomers having good mechanical properties and a glass transition temperature below −60° C., even below −80° C. or even lower.

Therefore, in one aspect there is provided a curable composition for making fluoroelastomers having a glass transition temperature of less than −60° C. said composition comprising a fluoropolymer and a fluoropolyether which can be cross-linked by forming triazine units.

More specifically there is provided curable compositions comprising

i. a fluoropolymer having a glass transition temperature (Tg) of less than 25° C. and having repeating units derived from a fluorinated olefin and further comprising at least one functional group,
ii. a fluoropolyether comprising repeating units selected from (—C₄F₈O—), (—CF₂CF₂O—) or (—CF₂O) or a combination thereof and further containing at least one functional group capable of reacting with the at least one functional group of the fluoropolymer either directly or in the presence of a curing compound to form a triazine unit wherein the composition can be cured to yield a composition containing triazine units and having a glass transition temperature of less than −60° C.

In another aspect there is provided a fluoroelastomer composition having a glass transition temperature of less than −60° C. and containing triazine units, and comprising the reaction product of a triazine forming curing reaction of the curable composition described above and wherein the composition has one or more or all of the mechanical properties selected from an elongation at break of at least 50%, a tensile strength of at least 1.5 MPa, or a shore A hardness of at least 15.

In a further aspect there is provided a method of making a fluoroelastomer containing triazine units and having a glass transition temperature of less than −60° C., comprising

i) providing a curable composition as described above;
ii) curing the composition to form triazine units.

In yet another aspect there is provided a shaped article comprising the fluoroelastomer composition described above.

In still a further aspect there is provided a method of preparing a shaped article comprising subjecting a curable composition as described above to curing in a mold.

### DETAILED DESCRIPTION

Before any embodiments of this disclosure are explained in detail, it is to be understood that the disclosure is not limited in its application to the details of compositions and the arrangement of components set forth in the following description. The invention is capable of other embodiments and of being practiced or of being carried out in various ways. Also, it is to be understood that the phraseology and terminology used herein is for the purpose of description and should not be regarded as limiting. Contrary to the use of “consisting”, the use of “including,” “containing”, “comprising,” or “having” and variations thereof is meant to be of broad scope and is meant to encompass the items listed thereafter, equivalents thereof and further items. The word “consisting of” is meant to be of limiting scope and is meant to encompass only the items listed thereafter and equivalents thereof but not any additional items. The term “consisting essentially of” has a meaning as defined in the description below.

The use of “a” or “an” is meant to encompass “one or more”. The recitation of all numerical ranges by endpoints is meant to include the endpoints of the range, all numbers subsumed within the range, and any range within the stated range. For example, a concentration range of from 1% to 50% is intended to be an abbreviation and to expressly disclose the values between the 1% and 50%, such as, for example, 2%, 40%, 10%, 30%, 1.5%, 3.9% and so forth.

As used herein the term “fluorinated compounds” refers to chemical compounds having at least one carbon-bonded hydrogen atom replaced by fluorine and specifically includes perfluorinated compounds and partially fluorinated compounds. As used herein the term “perfluorinated compounds” means that all carbon-bonded hydrogen atoms of a compound have been replaced by fluorine. For example, a —CF₃ group is referred to as a perfluoromethyl group. A —CF₂H or a —CFH₂ groups are partially fluorinated methyl group. When the term “perfluorinated” is used with respect to polymers it is meant that the polymer is made by using only perfluorinated monomers (e.g. CF₂═CF₂ or CF₂═CF—O—CF₃). It is understood that such a polymer may still contain minor amounts of hydrogen atoms in functional groups if applicable or in end-groups which may be generated through chain transfer agents or chain termination reactions.

“Fluoroelastomers” as referred to herein are fluoropolymers having a glass transition (Tg) temperature below 25° C. Therefore, the polymers are elastomeric at room temperature. Furthermore, the fluoroelastomers have sufficient mechanical strength that they can be molded into shaped articles. This typically means they have a tensile strength of at least 1 MPa and an elongation at break of at least 50% (see method section).

It has now been found that fluoroelastomers having good mechanical properties and very low glass transition temperatures can be prepared by curing a curable precursor composition containing a first compound, which is a fluoropolymer having a glass transition temperature of less than 25° C. and containing one or more functional groups and a second compound which is a fluoropolyether containing one or more functional groups. The functional groups of the fluoropolymer and the functional groups of the fluoropolyether are chosen such that they react with each other either directly or indirectly to form triazine units thereby forming a triazine-cross-linked network, i.e., they can be cured to form triazine crosslinks. “Directly reacting” means the functional groups react with each other simply by applying heat (e.g. by heating to 177° C. for 7 minutes). “Indirectly reacting” means the functional groups react with each other by using a curing compound which may be a curing agent or a catalyst. It is understood that the amount and ratio of the functional groups is chosen such that the triazines can be formed and the precursor composition can be cured into a triazine group containing fluoroelastomer compositions.

The components and methods will now be described in greater detail below.

### First Compounds

The first compounds of the compositions and methods provided herein is a fluoropolymer, more specifically, a fluoropolymer comprising repeating units derived from a perfluorinated olefin and further comprising at least one functional group. The fluoropolymer is a fluoroelastomer. Therefore, the first compound has a glass transition temperature below 25° C. Preferably, the first compound is amorphous, i.e. it is non crystalline. Non-crystalline compounds do not have a melting point, or at least no distinct melting point, i.e. a melting process completed within a temperature interval of less than 5° C.

Suitable perfluorinated olefins include those represented by the formula CF₂═CX—R_{f}, wherein X is F, Cl or CF₃ and R_{f} is fluorine or a C1-C8 fluoroalkyl, that may or may not contain one or more catenary oxygen atoms. Catenary oxygen atoms are oxygen atoms interrupting the carbon-carbon chain. Examples of suitable olefins include tetrafluoroethylene (TFE), hexafluoropropylene (HFP), and chlorotrifluoroethylene (CTFE). A particularly suitable olefin includes TFE. Preferably, the first compound comprises predominantly repeating units derived from TFE or from TFE and HFP.

“Predominantly” means that repeating units derived from these monomers are the major component (by weight) of the polymer.

The fluoropolymers may further comprise interpolymerized units derived from one or more perfluorinated vinyl or allyl ethers. Suitable perfluorinated ethers include, for example, CF₂═(CF₂)ₙ—CFOCF₃, CF₂═(CF₂)ₙ—CFOCF₂CF₂OCF₃, CF₂═(CF₂)ₙ—CFOCF₂CF₂CF₂OCF₃, CF₂═(CF₂)ₙ—CFOCF₂CF₂CF₃, CF₂═(CF₂)ₙ—CFOCF₂CF(CF₃)OCF₂CF₂CF₃, and CF₂═(CF₂)ₙ—CFOCF₂CF(CF₃)OCF₂CF(CF₃)OCF₂CF₂CF₃, wherein n represents 1 (in case of allyl ethers) or 0 (in case of vinyl ethers).

The fluoropolymers may optionally comprise repeating units derived from monomers that are non perfluorinated monomers, for example, partially fluorinated olefins or non-fluorinated olefins. Suitable monomers include those of the formula CX₂═CX—R, wherein each X independently represents, H, F or Cl, R is H, F, or a C₁-C₁₂, preferably C₁-C₃ alkyl group with the proviso that at least one X is not F.

Suitable examples of partially-fluorinated monomers include vinylidene fluoride (VDF). Suitable examples of non-fluorinated hydrogen-containing monomers include hydrocarbon olefins, such as for example ethylene, propylene, butene, pentene, hexene, and the like. Combinations of the above-mentioned optional monomers may also be used.

In one embodiment, the first compound is perfluorinated, which means it is exclusively derived from perfluorinated monomers.

The fluoropolymers further comprise at least one functional group. The functional group is chosen such that it can react with a functional group of the second compound (the fluoropolyether) to form triazines and thus forming triazine cross-linkings. The triazine formation may occur directly by reaction of the functional groups with each other or by means of a suitable curing compound, which may be a catalyst or a curing agent. It is to be understood that the functional groups are to be used in the appropriate stoichiometric ratios. For example if three functional groups are required to form a triazine, which, for example, may be the case if the functional groups of the first and second compounds are nitrile groups, the stoichiometric ratio may be achieved by using an excess of the first compound over the second compound or vice or versa of by using bi- or multifunctional first and/or second compounds and/or by using curing agents.

Preferably the functional group of the fluoropolymer comprises a nitrile group. The nitrile group can be introduced in the fluorinated polymer by copolymerizing a nitrile containing fluorinated olefin. Preferably, a perfluorinated olefin containing the functional group or a precursor thereof is used for this purpose. Such functional comonomers are sometimes also referred to as cure-site monomers. Suitable examples include nitrile-containing perfluorinated olefins or olefinic ethers. Examples of such monomers include but are not limited to those that correspond to one of the following formulae:

CF₂═CF—CF₂—O—Rf—CN;

CF₂═CFO(CF₂)ᵣCN;

CF₂═CFO[CF₂CF(CF₃)O]ₚ(CF₂)ᵥOCF(CF₃)CN;

CF₂═CF[OCF₂CF(CF₃)]ₖO(CF₂)ᵤCN;

CF₂═CFOCF₂CF₂O(CF₂)ᵣ(OCF₂)ₚO(CF₂)ᵤCN.

wherein, r represents an integer of 2 to 12; p represents an integer of 0 to 4; k represents 1 or 2; v represents an integer of 0 to 6; u represents an integer of 1 to 6, Rf is a perfluoroalkylene, perfluoroether or a perfluoropolyether group.

Specific examples of nitrile containing fluorinated monomers include perfluoro (8-cyano-5-methyl-3,6-dioxa-1-octene), CF₂═CFO(CF₂)₅CN, and CF₂═CFO(CF₂)₃OCF(CF₃)CN.

The amount of functional group containing monomers in the fluoropolymer preferably ranges from at least about 0.001 mole %, more preferably at least about 0.01 mole %. The amount of functional group containing monomers in the fluoropolymer preferably ranges from greater 0 to below about 5 mole %, more preferably below about 3 mole %.

A particularly suitable first compound is a TFE-based fluoroelastomer. In particular, it may comprise of at least 20%, preferably at least 30% by mole of repeating units derived from tetrafluoroethylene. In addition, it may comprise at least one perfluorinated vinyl ether and a nitrile containing monomer, preferably a perfluorinated nitrile containing monomer.

In such copolymers, the copolymerized perfluorinated vinyl ether units constitute from about 1 to about 60 mole % (more preferably 10 to 40 mole %) of total monomer units present in the polymer.

The first compounds are typically curable but may already be partially cross-linked. Such fluoropolymers may be prepared by methods known in the art but are also commercially available.

For example, the polymerization process can be carried out by free-radical polymerization of the monomers alone or as solutions, emulsions, or dispersions in an organic solvent or water.

Polymerization in an aqueous emulsion or suspension often is preferred because of the rapid and nearly complete conversion of monomers, easy removal of the heat of polymerization, and ready isolation of the polymer.

Emulsion or suspension polymerization typically involves polymerizing monomers in an aqueous medium in the presence of an inorganic free-radical initiator system, such as ammonium persulfate (APS) or potassium permanganate, and a surfactant or suspending agent.

Aqueous emulsion polymerization can be carried out continuously under steady-state conditions in which, for example, monomers, water, surfactants, buffers, and catalysts are fed continuously to a stirred reactor under optimum pressure and temperature conditions while the resulting emulsion or suspension is removed continuously (as is described, for example, in U.S. Pat. No. 5,789,489).

An alternative technique includes batch or semi-batch polymerization. This type of polymerization involves feeding the ingredients into a stirred reactor and allowing them to react at a set temperature for a specified length of time or by charging ingredients into the reactor and feeding the monomer into the reactor to maintain a constant pressure until a desired amount of polymer is formed.

The first compound typically has a larger molecular weight than the second compound. Typically the first compound has a molecular weight (or number average molecular weight), of at least 20,000 g/mole or at least 50,000 g/mole. The molecular weight may be determined by standard methods such a size exclusion chromatography or by calculating the polymerisation degree from the amount of monomers and initiator used and consumed in the polymerisation.

Typically, the first compound may be solid at room temperature, which means it is not pourable. “Pourable” as used herein means at least 1 g of a 10 g sample can be poured at ambient conditions (1 bar, 25° C.) from one container into another over period of 10 minutes. Not pourable accordingly means that no or less than 1 g of a 10 g sample can be poured into the other container within the specified period.

### Second Compounds

The curable compositions provided herein comprise a second compound, which is a fluoropolyether. The second compound contains repeating units selected from (—C₄F₈O—), (—CF₂CF₂O—) or (—CF₂O—), or a combination thereof, and further contains at least one functional group. That functional group is capable of reacting with the at least one functional group of the first compound either directly or in the presence of a curing compound to form a triazine unit.

Suitable polyethers include linear or branched or cyclic polyethers. Preferably, the polyethers are saturated. The fluorinated polyethers are preferably also perfluorinated.

Typically, the saturated fluoropolyethers consist essentially of units selected from (—C₄F₈O—), (—CF₂CF₂O—) or (—CF₂O—), or combinations thereof, such as (—C₄F₈O—) and (—CF₂CF₂O—), or (—C₄F₈O—) and (—CF₂O—), or (—CF₂CF₂O—) and (—CF₂O—), or (—C₄F₈O—), (—CF₂CF₂O—) and (—CF₂O—) and one or more functional groups capable of forming a triazine group. In one embodiment the fluoropolyethers comprise or consist essentially of (—CF₂CF₂O—) or (—CF₂O—) units, or of combinations thereof. The term “consisting essentially of” as used herein means the compound contains at least 80 mole %, preferably at least 90 mole %, of the afore-mentioned units. The remainder includes functional groups, linking groups and end groups. Linking groups and end groups preferably include perfluorinated alkyl and perfluorinated alkylene groups, respectively, wherein the carbon chain of those groups may or may not be interrupted by one or more oxygen atoms.

In one embodiment the fluorinated polyether consist essentially of repeating moieties selected from (—C₄F₈O—), (—CF₂CF₂O—), or (—CF₂O—), or combinations thereof, one or more groups Rf—Z and one or more groups Rf′—(Z′)ₙ, wherein Z and Z′ are different or identical functional groups capable of reacting with the at least one functional group of the first compound either directly or in the presence of a curing compound to form a triazine unit; Rf and Rf′ represent independently from each other perfluorinated alkyls or alkylenes that may or may not contain one or more oxygen atoms interrupting the carbon chain and n is 1 or 0. Preferably at least one, more preferably at least two of Rf—Z and Rf′—Z′ are placed at a terminal carbon atom of the backbone chain, or of a side chain if present. The terminal carbon atom may be a primary or secondary carbon atom.

In one particular embodiment the fluorinated polyethers comprising at least one functional group can be represented by the formula

XCF₂O(CF₂O)ₓ(CF₂CF₂O)_{y}(C₄F₈O)_{z}CF₂Y

wherein x and y are independent from each other integers from 2 to 12 and wherein z is an integer from 0 to 12 and wherein the CF₂O and CF₂CF₂O units, and C₄F₈O units if present, are placed randomly and wherein X and Y are the same or different functional groups as described above. In a particular embodiment at least one of X and Y, preferably both, are nitriles or precursor of nitriles.

A particular useful fluorinated polyether having two nitrile functional groups can be represented by the formula

NCCF₂O(CF₂O)ₓ(C₂F₄O)_{y}CF₂CN

wherein x and y are independent from each other integers from 2 to 12 and wherein the CF₂O and C₂F₄O (=—CF₂CF₂O—) units are placed randomly.

Such fluorinated polyether dinitrile can conveniently be prepared from the corresponding diester, commercially available from Solvay Solexis under the trade designation “FOMBLIN Z DEAL”.

The functional group of the second compound is a group capable of reacting with the functional group of the first compound to form a triazine. Such functional groups include nitrogen containing groups that can react with other nitrogen containing groups, optionally in the presence of a curing compound to form a triazine. Preferably they can react to form a triazine upon application of heat, for example upon a heat-treatment of for example 150° C. or 170° C. or higher, for example over a period of 5 minutes, 7 minutes or 15 minutes.

Typical examples of functional groups capable of forming a triazine by reacting with each other or by reacting with combinations of them include nitriles, amidines, imidoylamidines, imidates, amidrazones, amidoximes, and salts thereof.

Preferably, the fluoropolyethers are linear. Preferably, the functional group of the fluorinated polyether is a nitrile group. More preferably the fluorinated polyether contains two or more functional groups that can react with the one or more nitrile groups of the fluoroelastomer in the presence of a curing compound to form triazine rings, i.e. the fluorinated polyethers may be bifunctional or multifunctional. Preferably the two or more functional groups are all nitrile groups.

The at least one functional group typically is positioned at a terminal position (or a terminal carbon) of the fluorinated polyether, and more preferably at a primary or secondary carbon atom of the terminal position (the secondary carbons can be in the terminal position in case the compound is not linear but contains a side chain next to the terminal position).

“Terminal position” (or “terminal carbon”) as used herein encompasses the terminal position (or carbon) of the backbone and also the terminal position (or carbon) of a side chain in case of a non-linear fluorinated polyether.

“Primary carbon” means a carbon atom that is connected only to one other carbon or oxygen of the fluorinated polyether. A “secondary carbon” as used herein is a carbon that is connected to two other carbons or oxygens or to one oxygen and one carbon atom of the fluorinated polyether. For example, the carbon atoms of a F₃C— or F₃C—O— group of a CF₃—CF₂—, CF₃—O—CF₂—O— unit are primary carbons while the carbons of the —CF₂— or —O—CF₂—O— groups of that unit are secondary carbon atoms.

The fluorinated polyethers may be mixtures. Preferred are mixtures having a degree of bifunctionality of at least 50%, preferably at least 80%, more preferably at least 85% as can be determined, for example, with F-NMR.

The fluorinated polyethers are typically liquid at room temperature. The term “liquid” includes oils and means the substance is pourable at room temperature. Pourable means that at least 1 g, preferably 10 g of a 10 g sample can be poured from one container in another container of the same size within 10 minutes.

The second compounds are typically of lower molecular weight than the first compounds.

The fluorinated polyethers may generally have a molecular weight of less than 15,000 g/mole, typically from about 400 g/mole to about 15,000 g/mole, preferably less than 9,000 g/mole. The fluorinated polyethers may be mixtures and the molecular weight referred to above may be the weight average molecular weight. Typically the fluoropolyether have a weight average molecular weight from about 1,000 g/mole to about 9,000 g/mole.

In one embodiment, fluorinated polyethers having repeating units selected from —C₃F₆O—, can be used in combination with the saturated fluorinated polyethers described above. Suitable fluorinated polyether include perfluorinated polyethers that can be obtained by the polymerization of HFPO using dicarboxylic fluorides as polymerization initiators, as is described for example in U.S. Pat. Nos. 4,647,413 and 3,250,808. Perfluorinated polyether derived from HFPO contain branched perfluoroalkyl groups and at least one of the units (—C₃F₆O—) is not linear, e.g. the (—C₃F₆O—) is a —CF₂—CF(CF₃)—O— unit. HFPO derived perfluorinated polyethers are commercially available, for example, under the trade designation “KRYTOX”, from Dupont de Nemours.

Saturated fluorinated polyethers are known and their synthesis has been described since long. For example, fluorinated polyethers having a backbone characterized by blocks of repeating units of the formula —CF₂CF₂O— can be made from tetrafluoroethylene epoxide, as described in U.S. Pat. No. 3,125,599. Others, made by reacting oxygen with tetrafluoroethylene are characterized by a backbone made of repeating —CF₂O— units (see for example U.S. Pat. No. 3,392,097). Further useful examples of perfluorinated polyethers include those having a backbone of repeating —CF₂O— and —CF₂CF₂O— units (as is disclosed in U.S. Pat. No. 3,810,874).

The conversion of fluorinated polyether into fluorinated polyether containing functional groups capable to form triazine rings as those described below can be carried out by known methods of organic synthesis or can be carried out, for example, as described in U.S. Pat. No. 5,545,693. Functionalised fluorinated polyethers are also commercially available, for example under the trade designation “FOMBLIN, FOMBLIN Z DEAL” from Solvay Solexis and “DEMNUM” from Daikin.

Fluorinated polyether compounds having nitrile functional groups can be obtained, for example, from the corresponding precursor fluorinated polyethers as is described, for example, in U.S. Pat. No. 3,810,874 or U.S. Pat. No. 4,647,413 or U.S. Pat. No. 5,545,693. By their way of synthesis, the precursor fluorinated polyethers typically have acid fluoride end groups. These acid fluoride end groups may be converted to esters via reaction with an appropriate alcohol (such as methanol). The esters may be subsequently converted to amides via reaction with ammonia. The amides may then be dehydrated to nitriles in an appropriate solvent (such as DMF) with pyridine and trifluoroacetic anhydride. Alternatively the amides may be dehydrated with other reagents such as P₂O₅ or PCl₃.

Fluorinated polyethers having amidine functional groups can be obtained from a reaction of the corresponding nitrile compounds with ammonia as is disclosed, for example, in U.S. Pat. No. 3,810,874.

Fluorinated polyethers having amine functional groups can be obtained by reaction of an ester with amine-containing compounds, such as a diamine, as disclosed in U.S. Pat. No. 3,810,874.

Fluorinated polyethers having imidoylamidine functional groups can be obtained as is disclosed for example in U.S. Pat. No. 4,567,301.

Fluorinated polyethers having imidate functional groups can be obtained, for example, from a reaction of the corresponding nitriles with an alcohol as is described, for example, in U.S. Pat. Nos. 3,523,132 and 6,657,013.

Fluorinated polyethers having amidrazone functional groups can be obtained from a reaction of the corresponding nitriles with hydrazine, as is described for example in U.S. Pat. No. 5,637,648.

Fluorinated polyethers having amidoxime functional groups can be obtained, for example, from a reaction of the corresponding nitriles with hydroxylamine as is described for example in U.S. Pat. No. 4,145,524.

### Curing Compounds

In one embodiment, the curable compositions provided herein comprise a curing compound. The curing compound can be a curing catalyst or a curing co-agent.

A curing catalyst as used herein promotes a chemical reaction, in this particular case, a triazine formation, but is not consumed in the reaction, which means it is not incorporated into the triazine unit formed in the curing reaction. Examples of curing catalysts include organometallic catalysts, such as tetraphenyl tin, butyl tin and allyl-propargyl-allenyl-tin compounds. Further examples include ammonia, urea and acetaldehyde urea. Those catalysts are typically preferred for a system of functional groups comprising nitrile groups or precursors thereof.

A curing co-agent promotes the triazine formation, but is also consumed in the triazine formation reaction and can get incorporated into the polymer structure during the curing reaction.

In a preferred embodiment, the curing compound is a curing co-agent.

Suitable curing co-agents include compounds containing one or more functional groups linked to an organic residue. The functional group(s) are capable of reacting with the one or more functional groups of the first compound and with the at least one functional group of the second compound to form a triazine ring wherein the organic residue of the co-agent becomes part of the triazine moiety.

In one embodiment, the curing co-agent corresponds to the general formula

Y—(F)ₓ

Wherein F represents a functional group and salts thereof, Y represents an organic residue and x is 1 or 2. In one embodiment, Y is preferably a fluorinated residue, more preferably a perfluorinated residue. Typically, the co-agent is a compound that reacts with the at least one functional group of the first compound and the at least one functional group of the second compound to form a triazine thus linking the fluoroelastomer with the fluorinated polyether and the co-agent. The formation of the triazine can be established using FT-IR (strong absorption peak at 1550-1560 cm⁻¹).

Examples of functional groups (F) include, but are not limited to, nitriles, amines, amidines, imidates, amidoximes, amidrazones and their salts and combinations thereof. The co-agent can be monofunctional, bifunctional or multifunctional which means it contains either one, two or more functional groups, which may be identical or different from each other. Mixtures of mono, di- and multifunctional co-agents can also be used. The functional groups are preferably on a primary or secondary carbon.

In a preferred embodiment, examples of Y include residues comprising at least one —CF₂— or —CF₂—O— moiety. Typical examples of fluorinated residues include perfluoroalkyl, perfluoroalkylene, perfluorooxyalkyl perfluorooxyalkylene, perfluoropolyoxyalkyl or perfluoropolyoxyalkylene residues.

Preferably, both the fluoroelastomer and the fluorinated polyether contain nitrile groups and the functional group of the co-agent is not a nitrile group (or are not nitrile groups), but is selected from amines, amidines, imidates, amidoximes, amidrazones and salts thereof.

Examples of specific curing co-agents include hydrocarbon and fluorinated compounds containing mono- or bisamidine moieties, mono- or bisamino moieties, mono- or bisimidate moieties, mono- or bisamidrazone moieties, mono- and bisamidoxime moieties. Preferred co-agents include fluorinated mono- and bisamidine compounds and hydrocarbon or fluorinated mono- and bisamines.

Typical examples of monoamidine or bisamidine compounds include those according to the general formula:

R¹—C(═NH)NH₂

and

H₂N(HN═)C—R¹—C(═NH)NH₂

and salts thereof,
wherein R¹ represents an unsubstituted or substituted alkyl or alkylene group (e.g. a C1 to C20 alkyl or alkylene group), aryl group or arylene (e.g. a phenyl or naphthyl group) or aralkyl(arylalkylene) group (e.g. a toluoyl group). Preferably the R¹ groups are fluorinated and examples of suitable substituents include hydrogen, halogen (e.g. chlorine, bromine, iodine) and alkyloxy groups. In addition, one or more of the carbon groups may be substituted by one or more heteroatoms such as oxygen and nitrogen.

Preferably R¹ is a linear or branched perfluorinated C1-C10 group, wherein the carbon atoms may optionally be interrupted by oxygen atoms. Specific examples include C4 to C10 perfluoro alkyl (or alkylene), perfluorooxyalkyl (or alkylene) or perfluoropolyoxyalkyl (or alkylene) groups, such as CF₃—O—(CF₂)ₘ—O—CF(CF₃)—, wherein m is 1, 2, 3 or 4, and C₃F₇—(O—CF(CF₃)—CF₂)ₙ—O—CF(CF₃)—, wherein n is 0, 1, 2 or 3 or CF₃—O—(CF₂)ₚ—, or CF₃—(CF₂)ₚ— wherein p is 1, 2, 3, 4, 5, 6, 7, 8, or 9 or the corresponding alkylene groups in case of a bisamidine.

Useful salts of amidines include the carboxylic acid salts thereof. Particular useful carboxylic acids include perfluorinated carboxylic acids of formula CF₃(CF₂)ⱼCOOH, wherein j is an integer of 0 to 8, preferably 1 to 3.

Examples of useful amidines include monoamidines as described in U.S. Pat. No. 6,846,880 incorporated herein by reference, such as, for example, CF₃—O—CF₂CF₂—C(═NH)NH₂ and salts thereof. Further useful amidines include bisamidines, such as for example perfluorosebacamidine, commercially available from Apollo Scientific, UK.

Typical examples of useful amines include those of the formula:

R²—NH—R³

and

H₂N—R¹—NHR²

wherein R¹ is as defined above with respect to the amidines, R² represents hydrogen or an aliphatic group.

Examples of suitable amines include aliphatic, aromatic, heterocyclic or alicyclic mono and bis amines. Useful examples of aliphatic amines include ethylenediamine and hexamethylenediamine. Useful examples of aromatic and heterocyclic amines are as described in U.S. Pat. No. 6,956,085 and in U.S. Pat. No. 6,465,576. Further useful examples include aniline and melamine. Useful examples of fluorinated amines include 4-aminophenyl hexafluoropropane.

Further useful examples include compounds which decompose in-situ at a temperature between 40° C. and 330° C., to produce either a primary or secondary amine, such as described for example in U.S. Pat. No. 6,638,999.

Particularly useful examples of amine curing co-agents include hexamethylenediamine, hexamethylene diamine carbamate and 4-aminophenyl hexafluoropropane.

Typical examples of suitable imidates include those of the general formula:

HN═C(OR⁴)—R¹ and

HN═C(OR⁴)—R¹—C(OR^{4′})═NH

and salts thereof
wherein R¹ is as defined above with respect to the amidines.

R4 and R4′ represent, independently from each other, an unsubstituted or substituted alkyl group, such as C1-C10 alkyls, which may be branched or linear, an unsubstituted or substituted aryl group, —CH₂—Rf¹, —CH₂CH₂Rf¹, wherein Rf¹ is a perfluoro or partially fluorinated C1-C10 group.

Typical examples of suitable imidates are described, for example, in U.S. Pat. No. 6,657,013, incorporated herein by reference.

Examples of suitable amidrazones include compounds according to the general formula:

R¹[—C(NH)NHNH₂]ₙ and salts thereof

wherein R¹ is as defined above with respect to the amidines and n is 1 or 2. Typical examples include those as described in U.S. Pat. No. 5,637,648, incorporated herein by reference.

Examples of suitable amidoximes include compounds according to the general formula

R¹—[C(NH₂)NOH]ₙ

wherein R¹ is as described above for the amidines and n is 1 or 2. Typical examples of suitable amidoximes are described, for example, in U.S. Pat. No. 5,668,221, incorporated herein by reference.

Suitable functional groups of the co-agent are also nitrile groups, in which case the functional group of the fluorinated polyether is preferably chosen not to be a nitrile group, but an amidine, amine, imidate, amidoxime or amidrazone and salts thereof. Suitable examples of nitrile co-agents include mono- and dinitriles, such as, for example, perfluoroalkyl mono- and dinitriles or dinitriles derived from HFPO (hexafluoropropene oxide).

### Fillers

Preferably, the curable and cured compositions further comprise at least one filler. In one aspect, fillers are used to facilitate mixing of the first and second compounds. The second compound (the fluorinated polyethers), which is typically present as a liquid, may be pre-dispersed onto the filler. The pre-dispersed fluorinated polyethers can then more easily be dispersed into and blended with the first compound.

In another aspect, fillers can also be used to modify or adapt the rheological properties of the cured fluoroelastomer compositions.

Fillers are typically particles. The particles may be spherical or non-spherical. They may be rods, platelets or fibers or be of no particular shape. Typically they have a length or a diameter less than 5,000 μm, or even less than 1,000 μm, or less than 500 μm. Fillers, in particular carbon or silica-containing materials are available in particles sizes (number average) as small as between 0.05 and 30 μm.

Fillers include inorganic or organic materials. Typical fillers include silicon-containing materials. Examples of silicon-containing fillers include silica (also referred to as silicon dioxides). Specific examples of silica include hydrophilic and hydrophobic silica, fumed silica (which are, for example, commercially available under the trade designation “AEROSIL” from Evonik GmbH, Frankfurt, Germany (such as AEROSIL 200, AEROSIL R972 or AEROSIL R974), or under the trade designation “NANOGEL” from Cabot Corporation), silane-treated fumed silicas (commercially available, for example, under the trade designation “CABOSIL” from Cabot Corporation) and combinations thereof. Further examples include silicates such as, for example, calcium silicates, aluminum silicates, magnesium silicates and mixtures thereof, such as for example mica and clays. Further examples of suitable silica materials include nitrile-modified silica. Nitrile-modified silica can be prepared by reacting a commercially available hydroxyl containing silica, such as, for example, AEROSIL 200V (available from Evonik), with a cyano-silane, such as, for example, 3-cyanopropyltriethoxysilane (available from Aldrich), in the presence of ethanol containing hydrochloric acid. The amount of reactants is chosen so as to obtain between 10 and 30% (by weight) of nitrile-modified silica. Further suitable silica-containing fillers include fluorine-modified silica. Fluorine-modified silica can be prepared, for example, by reacting a commercially available hydroxyl containing silica, (for examples AEROSIL 200V) with a fluorosilane. A suitable fluorosilane includes HFPO-silanes, which may be prepared from oligomeric HFPO-esters and a silane, such as for example aminoalkyltrialkoxy silane, as is described in U.S. Pat. No. 3,646,085. Further suitable fluorosilanes can be derived from commercially available perfluoropolyethers, such as, for example, FOMBLIN Z Deal (Solvay Solexis) that have been reacted with aminoalkyltrialkoxy silanes, such as 3-aminopropyltrimethoxysilane, as is described in U.S. Pat. No. 6,716,534. The amount of reactants is typically chosen so as to obtain between 1 and 5% (by weight) of fluorine modified silica.

Other examples of suitable fillers include carbon-based materials. Carbon-based materials include, for example, graphite, carbon nanotubes, carbon black or subtypes thereof like, for example, acetylene black, ketchen black, and modified carbons, such as, for example graphite fluoride. Graphite fluoride is commercially available, for example, from Central Glass. Carbon black is commercially available, for example, from Cabot Corporation.

In a preferred embodiment, fillers used to pre-disperse the second compound have a high surface area or large pore volume, such as for example nanoparticles. Examples include fumed silica nanoparticles, commercially available under the trade designation NANOGEL (available from Cabot Corporation). Such fillers are of particular interest because they can typically be loaded with the fluorinated polyether in amounts as high as 50% by weight, preferably as high as 90% by weight.

Mixtures of fillers may also be used.

The fillers may typically be added in a total amount between about 5 to about 50 parts, or between about 10 and 30 parts, by weight based on the total weight of the composition.

The curable and cured compositions may include further additives. Examples include pigments, antioxidants, processing aids, rheology modifiers, lubricants, flame retardants, flame retardant synergists, antimicrobials, and further additives known in the art of fluorinated polymer compounding and rubber processing.

### Method of Making the Fluoroelastomers and Fluoroelastomer Compositions:

For making fluoroelastomers containing triazine groups and having a glass transition temperature of less than about −60° C. or less than −80° C. the first and second compounds and optionally a curing compound and fillers as described above are combined and cured to form the triazines.

The first and second compounds and the optional curing compound are used in effective amounts to produce fluoroelastomers having the glass transition temperatures described above and/or to produce fluoroelastomer compositions having one or more or all of the mechanical properties described below. Typically, the second compound is used in amount of more than about 10 parts, preferably at least 20 parts, more preferably at least 30 parts or even 50 parts by weight per 100 parts of the first compound. The first and second compounds are used in great excess compared to the optional curing compound. Typically, about 0 to about 10 parts, or about 0.2 to about 5 parts of the curing compound are used per 100 parts of the first compound and second compounds (all based on weight).

A typical embodiment of a curable composition includes the following:

A first compound having at least one nitrile group and a second compound having at least one nitrile groups. The composition may further contain a curing catalyst or a curing agent containing one or more nitrile groups or one or more nitrogen containing functional groups as described above. The composition further comprises one or more fillers.

To prepare the curable precursor compositions, in a first step, the second compound (fluorinated polyether) is typically mixed with a filler to pre-disperse the fluorinated polyether. Known mixing devices such as, for example, rotary mixers, planetary roll mixers, a high speed dispenser or a Hauschild™ Speedmixer may be used. For good mixing with the first compound, it is preferred that the mixture of second compound and filler is in the form of a powder. To this mixture further fillers and additives may be added.

This composition may then be compounded homogeneously with an optional curing compound and the first compound using conventional rubber mixing devices, such as Banbury mixers or roll mills. The temperature of the mixture during mixing typically may not rise above about 120° C. During mixing the components and additives are distributed uniformly.

The resulting mixture can then be extruded or pressed in a mold, e.g., a cavity or a transfer mold and subsequently be oven-cured. In an alternative embodiment curing can be done in an autoclave. By using suitable molds shaped article may be prepared or shaped articles may be prepared by cutting the cured compositions into the desired shape. Shaped articles include, for example, gaskets (e.g. O-rings), valves, connectors, hoses, bearings etc.

Curing is typically achieved by heat-treating the composition. The heat-treatment is carried out at an effective temperature and effective time to create a cured fluoroelastomer having triazine units. Optimum conditions can be tested by examining the resulting fluoroelastomer for its mechanical and physical properties. Typically, the curing is carried out at a temperature of greater than 120° C., greater than 150° C. or at least 170° C. Typical curing conditions include temperatures between 160° C. and 210° C., typically 177° C. during 3 to 90 minutes. A pressure of 10 to 100 bar may be applied during the curing. A post cure may be applied, typically at a temperature of between 200° C. and 250° C. for 16 hours to provide completely cured compositions. “Completely cured” means that the there is no increase in triazine formation or that there is no increase in tensile strength and elongation at break of a given sample.

The cured fluoroelastomers typically reach a delta torque (MH-ML) greater 0 (measured according to ASTM D 5289-93a) and have an onset of cure (as indicated by Ts2) greater 0 after less than 10 min curing at 177° C.

The method described above allows for the provision of fluoroelastomers having one or more or all of the following properties:

(i) a transition temperature (Tg) of less than −60° C., preferably less than −80° C.,
(ii) an elongation at break of at least 50%, preferably at least 100% or even at least 150%;
(iii) a tensile strength of at least 1.5 MPa, preferably at least 2 MPa;
(iv) a shore A hardness of at least 15, preferably at least 25 and more preferably at least 40.

Typical embodiments have a glass transition temperature of less than −80° C., a tensile strength of at least 2 MPa, a shore A hardness of at least 25, an elongation at break of at least 180%.

The invention will now be further illustrated by means of particular embodiments, which are used for illustrative purposes only and are not meant to be limiting the invention thereto:

1. A curable composition comprising
i. a fluoropolymer having a glass transition temperature (Tg) of less than 25° C. and having repeating units derived from a fluorinated olefin and further comprising at least one functional group,
ii. a fluoropolyether comprising repeating units selected from (—C₄F₈O—), (—CF₂CF₂O—) or (—CF₂O) or a combination thereof and further containing at least one functional group capable of reacting with the at least one functional group of the fluoropolymer either directly or in the presence of a curing compound to form a triazine unit.
wherein the composition can be cured to yield a cured composition containing triazine units and having a glass transition temperature of less than −60° C.
2. The composition of 1 wherein the fluoropolyether contains repeating —(CF₂O)— and (CF₂CF₂O)— units.
3. The composition of 1 or 2 wherein the fluoropolyether has a lower molecular weight than the fluoropolymer.
4. The composition according to any one of 1 to 3 wherein the fluoropolyether has a molecular weight or (number average molecular weight) of less than 15,000 g/mole.
5. The composition according to any of 1 to 4 wherein the fluoropolyether has a molecular weight (or number average molecular weight) of less than 15,000 g/mole as and more than 500, more than 1,000 g/mole or more than 5,000 g/mole.
6. The composition according to any one of 1 to 5 wherein the fluoropolyether is represented by the formula

XCF₂O(CF₂O)ₓ(CF₂CF₂O)_{y}(C₄F₈O)_{z}CF₂Y
wherein x and y are independent from each other integers from 2 to 12 and wherein z is an integer from 0 to 12 and wherein the CF₂O and CF₂CF₂O units and C₄F₈O units if present are placed randomly and wherein X and Y are the same or different functional groups.
   7. The composition according to any one of 1 to 6 wherein the fluoropolyether is represented by the formula

NCCF₂O(CF₂O)ₓ(CF₂CF₂O)_{y}(C₄F₈O)_{z}CF₂CN
wherein x and y are independent from each other integers from 2 to 12 and wherein z is an integer from 0 to 12 and wherein the CF₂O and CF₂CF₂O units and C₄F₈O units if present are placed randomly.
   8. The composition according to any one of 1 to 8 wherein the fluoropolymer comprises repeating units derived from tetrafluoroethylene, or at least 20% or at least 35% mole of repeating units derived from tetrafluoroethylene.
   9. The composition according to any one of the 1 to 8 wherein the at least one functional group of the fluoropolymer is a nitrile.
   10. The composition according to any one of 1 to 9 wherein the at least one functional group of the fluoropolymer and the at least one functional group of the fluoropolyether are nitriles.
   11. The composition according to any one of 1 to 10 wherein the at least one functional group of the fluoropolyether is capable of reacting with the at least one functional group of the fluoropolymer in the presence of a curing compound to form a triazine unit and wherein the curing compound is a fluorinated curing co-agent.
   12. The composition of 11 wherein the curing co-agent contains at least one perfluorinated alkyl or perfluorinated alkylene moiety wherein the carbon atoms of the perfluorinated alkyl or alkylene moiety may be interrupted by one or more oxygen atoms.
   13. The composition according to any one of 11 or 12 wherein the curing co-agent comprises a moiety selected from amidines, amines, amidrazones, imidates, amidoxime and salts thereof and combinations thereof.
   14. The composition according to any one of 1 to 11 wherein the at least one functional group of the fluoropolyether is capable of reacting with the at least one functional group of the fluoropolymer in the presence of a curing compound to form a triazine unit and wherein the curing compound is an organometallic curing catalyst.
   15. The composition according to any one of 1 to 14 further comprising at least one filler.
   16. The composition according to any one of 1 to 15 having after curing an elongation at break of at least 150%.
   17. The composition according to any one of 1 to 16. having after curing a shore A hardness of at least 40.
   18. The composition according to any one of 1 to 17 having after curing a tensile strength of at least 2 MPa.
   19. The composition according to any one of 1 to 18 having after curing a glass transition temperature of less than about −80° C.
   20. The composition according to any one of 11 to 13 wherein the at least one functional group of the first compound and the at least one functional group of the second compound are nitriles.
   21. The composition according to any one of the preceding embodiments, wherein the composition can be cured to yield a cured composition containing triazine units and having a glass transition temperature of less than −60° C., preferably at a temperature of 170° C. for 90 minutes.
   22. A fluoroelastomer composition having a glass transition temperature of less than −60° C. and containing triazine units, and comprising the reaction product of a triazine forming curing reaction of the curable composition according to any one of lto 21.
   23. A method of making a fluoroelastomer containing triazine units and having a glass transition temperature of less than −60° C., comprising
   i) providing a composition according to any one of 1 to 21;
   ii) curing the composition to form triazine units.
   24. The method of 23 wherein the curing is carried out a temperature of at least 150° C., preferably at least 170° C.
   25. A shaped article comprising the composition of 22.
   26. The shaped article of 25 selected from moulded goods, bonded seals, bearings, hoses and gaskets, like, for example, O-rings.
   27. Method of preparing a shaped article comprising subjecting a composition according to any one of 1 to 21 to curing in a mold or autoclave.

The invention is further illustrated by the following examples. These following examples are provided to illustrate certain embodiments but are not meant to limit the invention thereto. Prior to that some test methods used to characterize materials and their properties will be described. Unless specified otherwise, percentages are percentages by weight with respect to the mass of the total compositions and add up in each case to 100 weight percent.

### EXAMPLES

### Test Methods

### Hardness:

Hardness Shore A (2″) was measured on samples that were post cured for 20 hours at 250° C., according to ASTM D-2240.

### Glass Transition Temperature (Tg):

Tg was measured by modulated temperature DSC using a TA Instruments Q200 modulated DSC, available from TA Instruments. Conditions of measurement: −150° C. to 50° C. @ 2 or 3° C./min, modulation amplitude of +−1° C./min during 60 sec. The Tg was measured after the samples were press cured at 177° C. for 7 min and also after post cure at 250° C. during 16 hours or 200° C. during 16 hours as indicated in the examples.

### Tensile Strength at Break, Elongation at Break and Stress at 100% Elongation:

These properties were determined using an Instron™ mechanical tester with a 1 kN load cell in accordance with DIN 53504 (S2 DIE). All tests were run at a constant cross head displacement rate of 200 mm/min. Each test was run three times. The values reported are averages of the three tests.

Stress at 100% Elongation, Elongation at Break, and Tensile Strength at Break were reported in units of Mega Pascals (MPa), %, and MPa respectively.

### Curing Properties:

Vulcanisation properties were measured using an Alpha Technologies Moving Die Rheometer (at 177° C.) in accordance with ASTM D 5289-93a, reporting minimum torque (ML), maximum torque (MH) and delta torque (which is the difference between MH and ML). Torque values are reported in in.lbs. Also reported are tg δ @ML and tg δ @MH. Further reported are parameters indicating the curing speed such as Ts2 (the time required to increase the torque by two units over the ML); T50 (the time to increase torque above ML by 50% of delta torque), and T90 (the time to increase torque above ML by 90% of delta torque), all of which were reported in minutes.

### Presence of Triazine Rings:

50 μm thin samples of cured or post cured samples were submitted to FT-IR analysis. The presence of triazine rings was indicated by a strong absorption peak at 1550-1560 cm⁻¹ in FT-IR analysis.

### Materials Used:

### First Compound (Fluoropolymer):

Compound 1: PFE-131 TX, a perfluoropolyether elastomer having pendant nitrile groups, commercially available from Dyneon LLC, US.

### Second Compound (Fluorinated Polyether):

Compound 2: Fluorinated polyether: NCCF₂O(CF₂O)₉₋₁₁(CF₂CF₂O)₉₋₁₁CF₂CN

The fluorinated polyether was made starting from perfluoropolyether diester CH₃OC(O)CF₂O(CF₂O)₉₋₁₁(CF₂CF₂O)₉₋₁₁CF₂C(O)OCH₃ (average molecular weight of about 2,000 g/mole, obtained under the trade designation Fomblin™ Z-DEAL from Solvay Solexis) according to the process described in U.S. Pat. No. 5,545,693, example 3. In a first step, the perfluoropolyether diester was converted to the corresponding dicarbonamide using ammonia gas. In a second step, the dicarbonamide was converted to the corresponding dinitrile.

### Curing Co-Agents

Co-agent 1: CF₃—O—CF₂CF₂—C(═NH)NH₃⁺⁻OOCCF₃, made according to U.S. Pat. No. 6,846,880 (Curative B in section examples, curatives, column 13, line 32).
Co-agent 2: perfluorosebacamidine, commercially available from Apollo Scientific, UK.
Co-agent 3: Hexamethylenediamine carbamate, commercially available from DuPont de Nemours.

### Fillers

“Nanogel”: hydrophobic fumed silica, available from Cabot Corporation
“Aerosil” R 972: partially hydrophilic fumed silica, commercially available from Evonik Fluorographite: carbon monofluoride, commercially available from Advanced Research Co.
“Cab-O-Sil” TS530: available from Cabot Corporation
“Aerosil R200V”: hydroxyl containing silica, commercially available from Evonik
MT N-990: carbon black, medium thermal grade, available from Cancarb

### Sample Preparation

In a first step, the liquid fluorinated polyether was mixed with Nanogel in a Hauschild Speedmixer (1 min at 2000 rpm, 1 min at 3500 rpm). The resulting mixture was in the form of a powder. This powder was mixed with further fillers and the fluoropolymer and then homogeneously dispersed together with the curing agent into a gum on a roll mill.

Curing was carried out at 177° C. for 7 min and under a pressure of 20 bar. The fluoroelastomers were post cured in an oven during 16 hours at a temperature as indicated in the examples below.

### Examples 1, Example 2 and Comparative Example C-1

In examples 1 and 2 and comparative example C-1 curable compositions were prepared by blending the compounds as indicated in table 1, on a roll mill. The compositions were press cured at 177° C. during 7 min, followed by a post cure at 200° C. during 16 hours. The cured samples were tested for their rheological properties. The results are given in table 2.

TABLE 1
Composition of curable compositions (parts
per 100 parts compound 1 + compound 2)

| Compound | Ex 1 | Ex 2 | C-1 |
|---|---|---|---|
| Compound 1 | 80 | 50 | 100 |
| Compound 2 (90% | 22.22 | 55.55 | 0 |
| on Nanogel) | | | |
| Co-agent 1 | 1.37 | / | 1.37 |
| Co-agent 2 | / | 1.50 | / |
| Co-agent 3 | / | / | / |
| Nanogel | 4.00 | 5.00 | 4.00 |
| Aerosil R200V | 2.00 | / | 2.00 |
| Cab-O-Sil TS530 | 4.00 | 5.00 | 4.00 |
| Fluorographite | / | 10.00 | / |
| MT N-990 | / | 10.00 | / |

TABLE 2
Properties of cured fluoroelastomers

| Property | Ex 1 | Ex 2 | C-1 |
|---|---|---|---|
| ML (in · lbs) | 1.01 | 6.70 | 1.54 |
| MH (in · lbs) | 8.48 | 12.19 | 6.09 |
| MH-ML (in · lbs) | 7.47 | 5.49 | 4.55 |
| tg δ @ML | 0.78 | 0.55 | 0.79 |
| tg δ @MH | 0.08 | 0.34 | 0.17 |
| Ts2 (min) | 1.30 | 1.24 | 1.22 |
| T50 (min) | 2.11 | 1.46 | 1.36 |
| T90 (min) | 9.80 | 2.76 | 5.85 |
| Hardness shA | 68 | 89 | 75 |
| Stress at 100% elongation (MPa) | 2.2 | NA | 5.0 |
| Tensile strength (MPa) | 10.2 | 3.4 | 20.3 |
| Elongation at break (%) | 274 | 65 | 235 |
| Tg 1 (° C.) press cured | −6.23 | −4.47 | −0.68 |
| Tg 2 (° C.) press cured | −118.3 | −116.5 | / |
| Tg 1 (° C.) post cured | −5.35 | −4.17 | −0.39 |
| Tg 2 (° C.) post cured | −121.1 | −119.5 | / |

### Examples 3 to 5

In examples 3 to 5, curable compositions were prepared by blending the compounds as indicated in table 3, using a roll mill. The compositions were press cured at 177° C. during 7 min, followed by a post cure at 250° C. during 16 hours. The cured samples were tested for their rheological properties. The results are given in table 4.

TABLE 3
Composition of curable compositions (parts
per 100 parts compound 1 + compound 2)

| Compound | Ex 3 | Ex 4 | Ex 5 |
|---|---|---|---|
| Compound 1 | 70 | 60 | 50 |
| Compound 2 (90% on Nanogel) | 33.33 | 44.44 | 55.55 |
| Co-agent 1 | 1.5 | 1.64 | 1.77 |
| Nanogel | 3.00 | 3.00 | 3.00 |
| Aerosil R972 | 15.00 | 15.00 | 15.00 |

TABLE 4
Properties of cured fluoroelastomers

| Property | Ex 3 | Ex 4 | Ex 5 |
|---|---|---|---|
| ML (in · lbs) | 1.70 | 1.49 | 1.83 |
| MH (in · lbs) | 8.32 | 8.11 | 7.45 |
| MH-ML (in · lbs) | 6.62 | 6.62 | 5.62 |
| Hardness shA | 90 | 86 | 89 |
| Stress at 100% elongation (MPa) | 4.5 | 3.1 | 3.6 |
| Tensile strength (MPa) | 9.5 | 3.8 | 3.6 |
| Elongation at break (%) | 385 | 330 | NA |
| Tg 1 (° C.) press cured | −4.66 | −8.46 | −5.82 |
| Tg 2 (° C.) press cured | −114.0 | −116.1 | −115.1 |

Note:
NA: not available

### Example 6

In example 6, a curable fluoroelastomer composition was prepared by blending the compounds as indicated in table 5, using a roll mill. The compositions were press cured at 177° C. during 7 min, followed by a post cure at 210° C. during 16 hours. The cured samples were tested for their rheological properties. The results are given in table 5.

TABLE 5

| Compounds | Ex 6 |
|---|---|
| Compound 1 | 80 |
| Compound 2 (90% on | 20 |
| Nanogel) | |
| Co-agent 3 | 0.7 |
| Aerosil R972V | 10 |
| Properties | |
| ML (in · lbs) | 2.61 |
| MH (in · lbs) | 9.05 |
| MH-ML (in · lbs) | 6.44 |
| Hardness shA (post cured) | 63 |
| Tensile (post cured; Mpa) | 5.4 |
| Elongation (post cured; %) | 180 |
| Tg 1 (° C.) post cured | −8.6 |
| Tg 2 (° C.) post cured | −120 |

What is claimed is:

1. A curable composition comprising
i. a fluoropolymer having a glass transition temperature (Tg) of less than 25° C. and having repeating units derived from a fluorinated olefin and further comprising at least one functional group,
ii. a fluoropolyether comprising repeating units selected from (—C₄F₈O—), (—CF₂CF₂O—) or (—CF₂O) or a combination thereof and further containing at least one functional group capable of reacting with the at least one functional group of the fluoropolymer either directly or in the presence of a curing compound to form a triazine unit,
wherein the composition can be cured to yield a cured composition containing triazine units and having a glass transition temperature of less than −60° C.

2. The composition according to claim 1 wherein the fluoropolyether has a lower molecular weight than the fluoropolymer.

3. The composition according to claim 1 wherein the fluoropolyether has a molecular weight (or number average molecular weight) of less than 15,000 g/mole

4. The composition according to claim 1 wherein the fluoropolyether is represented by the formula
XCF₂O(CF₂O)ₓ(CF₂CF₂O)_{y}(C₄F₈O)_{z}CF₂Y
wherein x and y are independent from each other integers from 2 to 12 and wherein z is an integer from 0 to 12 and wherein the CF₂O and CF₂CF₂O units, and C₄F₈O units if present, are placed randomly and wherein X and Y are identical or different functional groups capable of reacting with the at least one functional group of the first compound either directly or in the presence of a curing compound to form a triazine unit.

5. The composition according to claim 1 wherein the fluoropolymer comprises repeating units derived from tetrafluoroethylene.

6. The composition according to claim 1 wherein the at least one functional group of the fluoropolymer and the at least one functional group of the fluoropolyether are nitriles.

7. The composition according to claim 1 wherein the at least one functional group of the fluoropolyether is capable of reacting with the at least one functional group of the fluoropolymer in the presence of a curing compound to form a triazine unit and wherein the curing compound is a fluorinated curing agent, containing at least one perfluorinated alkyl or perfluorinated alkylene moiety wherein the carbon atoms of the perfluorinated alkyl or alkylene moiety may be interrupted by one or more oxygen atoms.

8. The composition according to claim 7 wherein the fluorinated curing agent comprises one or more functional groups capable of reacting with the at least one functional group of the first compound which are selected from amidines, amines, amidrazones, imidates, amidoxime and salts thereof and combinations thereof.

9. The composition according to claim 1 wherein the at least one functional group of the fluoropolyether is capable of reacting with the at least one functional group of the fluoropolymer in the presence of a curing compound to form a triazine unit and wherein the curing compound is an organometallic curing catalyst.

10. The composition according to claim 1 further comprising at least one filler.

11. The composition according to claim 1 wherein the fluoropolymer, fluoropolyether are present in a weight ratio of fluoropolymer to fluoropolyether of from about 8:1 to about 2:1.

12. A fluoroelastomer composition having a glass transition temperature of less than −60° C. and containing triazine units, and comprising the reaction product of a triazine forming curing reaction of the curable composition according to claim 1, wherein the fluoroelastomer composition has one or more or all of the mechanical properties selected from an elongation at break of at least 50%, a tensile strength of at least 1.5 MPa or a shore A hardness of at least 15.

13. A method of making a fluoroelastomer containing triazine units and having a glass transition temperature of less than −60° C., comprising
i) providing a composition according to claim 1;
ii) curing the composition to form triazine units.

14. The method of claim 13 wherein the curing is carried out a temperature of at least 150° C., preferably 170° C.

15. A shaped article comprising the composition of claim 12, wherein the shaped article is selected from seals, bearings, hoses, O-rings.

16. Method of preparing a shaped article comprising subjecting a composition according to claim 1 to curing in a mold.
